(19) United States
(12) Patent Application Publication
(10) Pub. No.: US 2015/0339131 A1
(43) Pub. Date: Nov. 26, 2015

(54) Method and device for deregistering terminal peripheral in machine type communication system, and gateway

(71) Applicant: ZTE CORPORATION, Shenzhen, Guandong (CN)

(72) Inventor: Hao Wu, Shenzhen (CN)

(21) Appl. No.: 14/438,948

(22) PCT Filed: Aug. 16, 2013
(86) PCT No.: PCT/CN2013/081690

§ 371 Date: Apr. 28, 2015

(30) Foreign Application Priority Data
Oct. 29, 2012 (CN) 201210420776.X

(51) Int. Cl. G06F 9/445; G06F 13/10

(52) U.S. Cl. CPC G06F 9/44505; G06F 13/102

(57) ABSTRACT

The present disclosure discloses a method for deregistering a terminal peripheral in a Machine Type Communication (MTC) system, which may include receiving, by a gateway, a first deregistration request message concerning the terminal peripheral, generating a second deregistration request message of the terminal peripheral, and sending the second deregistration request message of the terminal peripheral to a Machine to Machine (M2M) service platform or an M2M application; and after receiving a first deregistration confirmation message of the terminal peripheral sent by the M2M service platform or the M2M application, deleting, by the gateway, information of a local relevant terminal peripheral, and generating and sending a second registration confirmation message to the terminal peripheral. The present disclosure simultaneously discloses a device and a gateway for deregistering the terminal peripheral in the MTC system for implementing the above method. A technical scheme of the present disclosure can deregister registration information of the terminal peripheral in time, and guarantee a storage space of a network side and improve processing efficiency of the network side.

### TECHNICAL FIELD

The present disclosure relates to a terminal management technique in a Machine Type Communication (MTC) system, and particularly relates to a method and a device for deregistering a terminal peripheral in the MTC system, and a gateway.

### BACKGROUND

A Machine to Machine (M2M) communication network extends a scope and a field of communications of an existing information communication network, and obtains information from a physical world by embedding intelligence and communication ability in various possible objects, and increases and improves intellectuality, interactivity, and automaticity of an existing information communication network service based on analysis and processing of this information.

The M2M communication network has many network forms, and may be a singly constructed independent physical network, or may be a logic network constructed on an existing public communication network and various government and enterprise specific networks.

The M2M communication network may be divided into three layers based on a logic function, namely a perception extension layer, a network/service layer, and an application layer, wherein:

The perception extension layer mainly implements collection, automatic identification, and intelligent control of the information of the physical world. Various objects themselves in the physical world do not have the communication ability. An intelligent node, such as a sensor, an actuator, an intelligent device, a Radio Frequency Identification (RFID) reader-writer, and etc., collects the information of the physical world, and interacts with a network layer through a communication module. Main components contained by it are an M2M terminal device, an M2M gateway device, and etc.

The network/service layer supports transportation, routing, and control of the information of a perception layer, and provides support to the communications between a person and an object, and between the objects, in an Internet of Things (IOT). Combining with classification of the IOT, the network layer contains the following network forms: a communication network, an internet, an industrial network, and etc., which may mainly contain an M2M platform.

The application layer contains various applications of the IOT, not only contains a public service, but also contains an industrial service. Wherein the industrial service may be an industrial public service facing the public, and may also be an industry-specific service meeting a requirement of a special application inside an industry. Wherein, the public service may be a basic service which is provided, facing a common requirement of the public, such as an intelligent home, mobile payment, and etc. The industry-specific service is usually a service which is provided facing a peculiar need of the industry itself, and facing an interior of the industry, such as an intelligent power grid, intelligent traffic, an intelligent environment, and etc.; wherein a certain industrial service may also be provided facing the public, such as the intelligent traffic, and is called the industrial public service. The application layer mainly contains an M2M application server, and is also called an M2M application.

A terminal peripheral is referred to a single device having an environment perception function, such as a sensor and etc. which can send sensed information to an M2M service platform or an M2M application through an M2M gateway, and simultaneously can also receive downlink control thereof from the M2M application or the M2M service platform.

An M2M terminal has a peripheral and a feature such as limited processing ability, storage ability and power, and cannot directly communicate with the communication network, and needs to access the communication network through the M2M gateway. The M2M gateway can perform protocol conversion between an M2M perception extension layer and an upper-layer network. The M2M gateway can not only converge and forward data information collected by an M2M terminal peripheral, but also receive control information of the M2M application or M2M service platform, to manage the terminal peripheral.

The M2M service platform provides some common ability and support to the M2M application, and provides an open interface, so that an application can access and use a network resource and ability. By shielding the M2M application from lower-layer specific network implementation, complexity of developing an IOT application can be simplified and a cost of developing and deploying the IOT application can be lowered.

However, when the terminal peripheral governed by a certain gateway is needed to be replaced, old terminal information may still be stored in the gateway, when a number of replacement is too large and the number of the replaced terminal peripheral is large, the gateway may store more unnecessary information, resulting in a waste of a storage space, and finally resulting in that data of a new terminal peripheral cannot be stored, and the gateway cannot be operated normally.

### SUMMARY

In view of this, a main purpose of the present disclosure is to provide a method and a device for deregistering a terminal peripheral in an MTC system, and a gateway, so that an unavailable terminal peripheral can be deregistered if possible, to guarantee operation efficiency of an MTC system.

In order to achieve the above purpose, a technical scheme of the present disclosure is implemented like this:

A method for deregistering a terminal peripheral in an MTC system, which may include:

receiving, by a gateway, a first deregistration request message concerning the terminal peripheral, generating a second deregistration request message of the terminal peripheral, and sending the second deregistration request message of the terminal peripheral to an M2M service platform or an M2M application; and

after receiving a first deregistration confirmation message of the terminal peripheral sent by the M2M service platform or the M2M application, deleting, by the gateway, information of local relevant terminal peripheral, and generating and sending a second registration confirmation message of the terminal peripheral to the terminal peripheral.

Preferably, the first registration request message at least contains an identifier of the terminal peripheral to be deregistered.

Preferably, the second deregistration request message at least contains an identifier of the gateway, the identifier of the terminal peripheral to be deregistered, or an identifier list of the terminal peripheral to be deregistered.

Preferably, the generating the second deregistration request message of the terminal peripheral may include:

after receiving the first registration request message of the terminal peripheral, immediately generating, by the gateway, the second registration request message of the terminal peripheral;

or, when a preset period comes, generating, by the gateway, the second deregistration request message;

or, when determining that a number of the terminal peripheral to be deregistered exceeds a preset threshold, generating, by the gateway, the second deregistration request message; wherein, the preset threshold is larger than or equal to a maximum number of the terminal peripheral which can be carried by the identifier list of the terminal peripheral to be deregistered of the second deregistration request message.

Preferably, the second deregistration confirmation message at least contains an identifier of a deregistered terminal peripheral; and

the first deregistration confirmation message at least contains the identifier of the deregistered terminal peripheral or an identifier list of the deregistered terminal peripheral.

Preferably, the information of the local relevant terminal peripheral deleted by the gateway at least includes an identifier of the terminal peripheral, and an address of the terminal peripheral.

Preferably, the method may further include:

after receiving the second deregistration request message, deleting, by the M2M service platform or the M2M application, the information of the relevant terminal peripheral according to the identifier of the terminal peripheral or an identifier list of the terminal peripheral in the second deregistration request message, wherein the information of the relevant terminal peripheral at least comprises the identifier of the terminal peripheral, and the identifier of the gateway registered by the terminal peripheral.

A device for deregistering a terminal peripheral in an MTC system, which may include: a receiving unit, a generating unit, a deleting unit, and a sending unit, wherein

the receiving unit is configured to receive a first deregistration request message concerning the terminal peripheral, and to receive a first deregistration confirmation message of the terminal peripheral sent by a Machine to Machine (M2M) service platform or an M2M application;

the generating unit is configured to generate a second deregistration request message of the terminal peripheral, and to generate a second deregistration confirmation message of the terminal peripheral;

the deleting unit is configured to delete information of local relevant terminal peripheral after the receiving unit receives the first deregistration confirmation message; and

the sending unit is configured to send the second deregistration request message to the M2M service platform or the M2M application, and to send the second deregistration confirmation message to the terminal peripheral.

Preferably, the first registration request message at least contains an identifier of the terminal peripheral to be deregistered.

Preferably, the second deregistration request message at least contains an identifier of a gateway, the identifier of the terminal peripheral to be deregistered, or an identifier list of the terminal peripheral to be deregistered.

Preferably, the generating unit is further configured to,

immediately generate the second registration request message of the terminal peripheral after receiving the first registration request message of the terminal peripheral;

or, generate the second deregistration request message when a preset period comes;

or, the generating unit is further configured to generate the second deregistration request message when determining that a number of the terminal peripheral to be deregistered exceeds a preset threshold; wherein, the preset threshold is larger than or equal to a maximum number of the terminal peripheral which can be carried by an identifier list of the terminal peripheral to be deregistered of the second deregistration request message.

Preferably, the second deregistration confirmation message at least contains an identifier of a deregistered terminal peripheral; and

the first deregistration confirmation message at least contains the identifier of the deregistered terminal peripheral or an identifier list of the deregistered terminal peripheral.

A gateway in an MTC system may include the above device for deregistering the terminal peripheral.

In the present disclosure, the gateway receives the first deregistration request message concerning the terminal peripheral, and generates and sends the second deregistration request message of the terminal peripheral to the M2M service platform or the M2M application; after receiving the first deregistration confirmation message of the terminal peripheral sent by the M2M service platform or the M2M application, the gateway deletes the information of local relevant terminal peripheral, and generates and sends the second registration confirmation message of the terminal peripheral to the terminal peripheral. Wherein the gateway generates the second deregistration request message when the preset period comes, or generates the second deregistration request message when determining that the number of the terminal peripheral to be deregistered exceeds the preset threshold. According to the present disclosure, when the terminal peripheral governed by a certain gateway is unavailable, relevant information for deregistering this terminal peripheral is sent to the gateway through this unavailable terminal peripheral, the gateway notifies the M2M service platform or the M2M application of the information of the terminal peripheral to be deregistered in batches in accordance with a certain comprehensive processing way, and these terminal peripherals are deregistered by the M2M service platform or the M2M application; after receiving a deregistration confirmation message of the M2M service platform or the M2M application, the gateway deletes local registration information of the relevant terminal peripheral, to completely deregister the terminal peripheral, and notifies the terminal peripheral or a gateway centre. In this way, registration relevant information of the unavailable terminal peripheral is not stored at a network side any more, and a storage space at the network side is saved. Besides, because the network side does not store useless registration information of the terminal peripheral, efficiency of maintaining the registration information of the terminal peripheral by the network side will be greatly improved. With regard to the terminal peripheral in the MTC system which has a huge data amount, the technical scheme of the present disclosure can deregister the registration information of the terminal peripheral in time, guarantee the storage space of the network side, and improve processing efficiency of the network side.

### BRIEF DESCRIPTION OF THE DRAWINGS

FIG. 1 is a flowchart of a method for deregistering a terminal peripheral in an MTC system of an embodiment of the present disclosure; and

FIG. 2 is a structure diagram of a device for deregistering a terminal peripheral in an MTC system of an embodiment of the present disclosure.

### DETAILED DESCRIPTION

In an embodiment of the present disclosure, a gateway receives a first deregistration request message concerning a terminal peripheral, and generates and sends a second deregistration request message of the terminal peripheral to an M2M service platform or an M2M application; and after receiving a first deregistration confirmation message of the terminal peripheral sent by the M2M service platform or the M2M application, the gateway deletes information of a local relevant terminal peripheral, and generates and sends a second registration confirmation message of the terminal peripheral to the terminal peripheral.

In order to make a purpose, a technical scheme, and an advantage of the present disclosure more clear and explicit, the present disclosure is further illustrated in detail below by giving an embodiment with reference to an accompanied drawing.

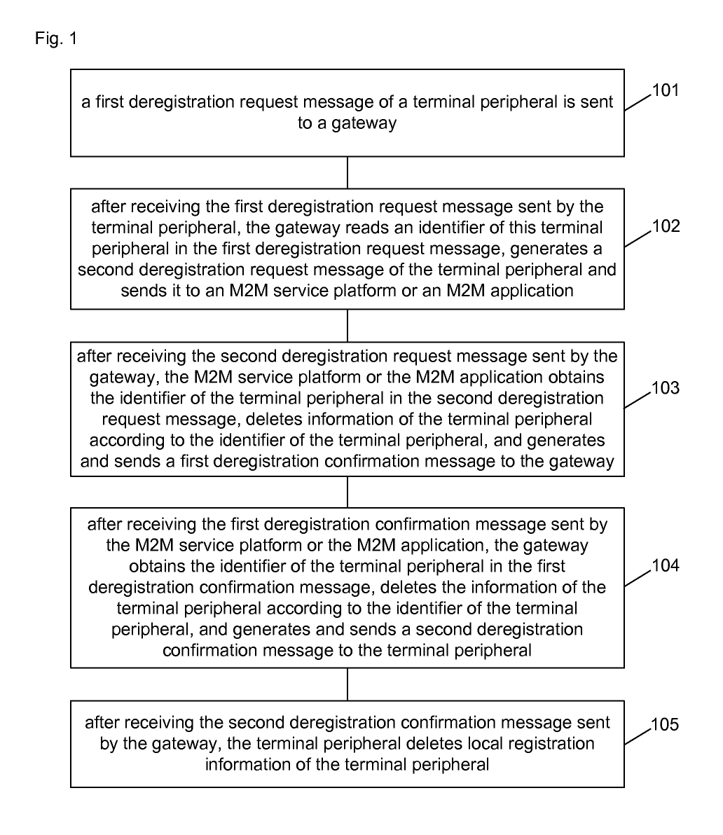

FIG. 1 is a flowchart of a method for deregistering a terminal peripheral in an MTC system in an embodiment of the present disclosure, as shown in FIG. 1, the method for deregistering the terminal peripheral in the MTC system of this embodiment includes the following steps:

Step 101, a first deregistration request message of a terminal peripheral is sent to a gateway.

In the present disclosure, the first deregistration request message contains an identifier of a message type and the identifier of the terminal peripheral. A format of the first deregistration request message of the terminal peripheral of this embodiment may be referred in Table 1 below. In Table 1, a protocol identifier is also the identifier of the message type.

In this step, the first deregistration request message may be sent by the terminal peripheral to be deregistered, for example when the terminal peripheral is not used, the terminal peripheral actively sends the first deregistration request message to the gateway.

TABLE 1

| Reference | Remark |
|---|---|
| Protocol | The protocol identifier is used to identify that a |
| identifier | current message is “a deregistration request” |
| Identifier of | The identifier is used to set the terminal |
| terminal | peripheral needed to be deregistered |
| peripheral | |

Step 102, after receiving the first deregistration request message sent by the terminal peripheral, the gateway reads an identifier of this terminal peripheral in the first deregistration request message, and generates and sends a second deregistration request message of the terminal peripheral to an M2M service platform or an M2M application.

The second deregistration request message at least contains the identifier of the message type, the identifier of the gateway, the identifier of the terminal peripheral to be deregistration, or an identifier list. The format of the second deregistration request message of the terminal peripheral of this embodiment may be referred in Table 2 below.

TABLE 2

| Reference | Remark |
|---|---|
| Protocol | The protocol identifier is used to identify that the |
| identifier | current message is “a terminal peripheral |
| | deregistration request” |
| Identifier of | The identifier is used to set the gateway which is |
| gateway | sending a message currently |
| Identifier of | The identifier or the identifier list is used to set |
| terminal | the terminal peripheral needed to be deregistered |
| peripheral or | |
| identifier list | |

In this embodiment, the gateway receives the first deregistration request message sent by the terminal peripheral to be deregistered. However, the gateway does not generate and send the second deregistration request message to the M2M service platform or the M2M application once receiving the first deregistration request message, but performs deregistration of registration information of the terminal peripheral comprehensively after receiving a certain number of the first deregistration request messages. Of course, there is a single terminal peripheral to be deregistered, the first deregistration request message only contains the identifier of the terminal peripheral.

Specifically, after receiving the first registration request message of the terminal peripheral, the gateway immediately generates the second registration request message of the terminal peripheral;

or, the gateway generates the second deregistration request message when a preset period comes;

or, the gateway generates the second deregistration request message when determining that a number of the terminal peripheral to be deregistered exceeds a preset threshold; wherein, the preset threshold is larger than or equal to a maximum number of the terminal peripheral which can be carried by the identifier list of the terminal peripheral to be deregistered of the second deregistration request message.

Step 103, after receiving the second deregistration request message sent by the gateway, the M2M service platform or the M2M application obtains the identifier of the terminal peripheral in the second deregistration request message, deletes information of the terminal peripheral according to the identifier of the terminal peripheral, and generates and sends a first deregistration confirmation message to the gateway.

Here, the information of the terminal peripheral includes but is not limited to the identifier of the terminal peripheral and the identifier of the gateway registered by the terminal peripheral.

The first deregistration confirmation message contains the identifier of the terminal peripheral of which associated information is deleted or the information such as the identifier list, the message type, and etc. The format of the first deregistration confirmation message may be referred in Table 3.

TABLE 3

| Reference | Remark |
|---|---|
| Protocol | The protocol identifier is used to identify that the |
| identifier | current message is “deregistration confirmation |
| | of the terminal peripheral” |
| Identifier of | The identifier or the identifier list is used to set a |
| terminal | deregistered terminal peripheral. |
| peripheral or | |
| identifier list | |

Step 104, after receiving the first deregistration confirmation message sent by the M2M service platform or the M2M application, the gateway obtains the identifier of the terminal peripheral in the first deregistration confirmation message, deletes the information of the terminal peripheral according to the identifier of the terminal peripheral, and generates and sends a second deregistration confirmation message to the terminal peripheral.

Here, the information of the terminal peripheral includes but is not limited to the identifier of the terminal peripheral and an address of the terminal peripheral. The second deregistration confirmation message at least contains the identifier of the message type, and the identifier of the deregistered terminal peripheral. The format of the second deregistration confirmation message is referred in Table 4.

TABLE 4

| Parameter | Remark |
|---|---|
| Protocol | The protocol identifier is used to identify that the |
| identifier | current message is “deregistration confirmation” |
| Identifier of | The identifier is used to set the deregistered |
| terminal | terminal peripheral |
| peripheral | |

Step 105, after receiving the second deregistration confirmation message sent by the gateway, the terminal peripheral deletes local registration information of the terminal peripheral.

Here, the local registration information of the terminal peripheral may include the identifier of the gateway to which the terminal peripheral is registered, the identifier or the address allocated by the gateway.

When receiving the second deregistration confirmation message, the terminal peripheral directly deletes the local registration information.

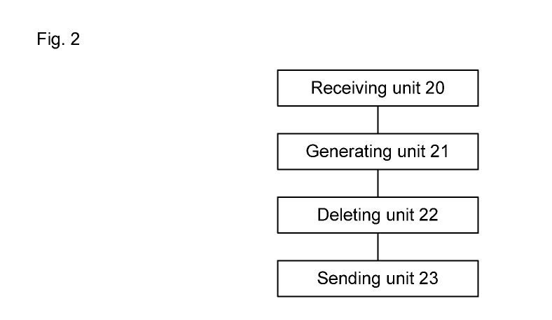

FIG. 2 is a structure view of a device for deregistering a terminal peripheral in an MTC system in an embodiment of the present disclosure, as shown in FIG. 2, the device for deregistering the terminal peripheral in the MTC system of embodiment of the present disclosure includes a receiving unit 20, a generating unit 21, a deleting unit 22, and a sending unit 23, wherein:

the receiving unit 20 is configured to receive a first deregistration request message concerning the terminal peripheral, and to receive a first deregistration confirmation message of the terminal peripheral sent by an M2M service platform or an M2M application;

the generating unit 21 is configured to generate a second deregistration request message of the terminal peripheral, and to generate a second deregistration confirmation message of the terminal peripheral;

the deleting unit 22 is configured to information of a local relevant terminal peripheral after the receiving unit receives the first deregistration confirmation message; and

the sending unit 23 is configured to send the second deregistration request message to the M2M service platform or the M2M application, and to send the second deregistration confirmation message to the terminal peripheral.

After receiving the second deregistration request message, the M2M service platform or the M2M application deletes information of the relevant terminal peripheral according to an identifier of the terminal peripheral in the second deregistration request message, and the information of the relevant terminal peripheral at least includes the identifier of the terminal peripheral, and the identifier of a gateway to which the terminal peripheral is registered.

The first registration request message at least contains the identifier of the terminal peripheral to be deregistered.

The second deregistration request message at least contains the identifier of the gateway, the identifier of the terminal peripheral to be deregistered, or an identifier list of the terminal peripheral to be deregistered.

The above generating unit 21 is further configured to immediately generate the second registration request message of the terminal peripheral after receiving the first registration request message of the terminal peripheral;

or, to generate the second deregistration request message when a preset period comes;

or, the above generating unit 21 is further configured to generate the second deregistration request message when determining that a number of the terminal peripheral to be deregistered exceeds a preset threshold; wherein, the preset threshold is larger than or equal to a maximum number of the terminal peripheral which can be carried by the identifier list of the terminal peripheral to be deregistered of the second deregistration request message.

The above second deregistration confirmation message at least contains the identifier of a deregistered terminal peripheral;

the above first deregistration confirmation message at least contains the identifier of the deregistered terminal peripheral or the identifier list of the deregistered terminal peripheral.

Those skilled in the art shall understand that functions implemented by various processing units in the device for deregistering the terminal peripheral in the MTC system of the present disclosure may be understood with reference to a relevant description of the above method for deregistering the terminal peripheral in the MTC system. Those skilled in the art shall understand that the functions of various processing units in the device for deregistering the terminal peripheral in the MTC system which is shown in FIG. 2 may be implemented through a program operating in a processor, and may also be implemented through a specific logic circuit.

The present disclosure also records a gateway in an MTC system, which includes the above device for deregistering the terminal peripheral shown in FIG. 2.

Of course, those skilled in the art shall understand that various processing units or steps of the present disclosure above may be implemented by a computing device, which may be concentrated in a single computing device, or may be distributed in a network composed of multiple computing devices, and optically may be implemented by a program code which can be executed by the computing device, so that they may be stored in a storage device to be executed by the computing device, or they may be separately made into various integrated circuit modules, or multiple modules or steps of them may be made into a single integrated circuit module for implementation. In this way, the present disclosure is not limited to any specific combination of hardware and software.

All those described above are only preferred embodiments of the present disclosure, and are not used to limit the scope of protection of the present disclosure.

### INDUSTRIAL APPLICABILITY

Through the technical scheme of the present disclosure, when the terminal peripheral governed by a certain gateway is unavailable, relevant information for deregistering this terminal peripheral is sent to the gateway through this unavailable terminal peripheral, the gateway notifies the M2M service platform or the M2M application of the information of the terminal peripheral to be deregistered in batches in accordance with a certain comprehensive processing way, and these terminal peripherals are deregistered by the M2M service platform or the M2M application; after receiving a deregistration confirmation message of the M2M service platform or the M2M application, the gateway deletes local registration information of the relevant terminal peripheral, to completely deregister the terminal peripheral, and notifies the terminal peripheral or a gateway centre. In this way, registration relevant information of the unavailable terminal peripheral is not stored at a network side any more, and a storage space at the network side is saved. Besides, because the network side does not store useless registration information of the terminal peripheral, efficiency of maintaining the registration information of the terminal peripheral by the network side will be greatly improved. With regard to the terminal peripheral in the MTC system which has a huge data amount, the technical scheme of the present disclosure can deregister the registration information of the terminal peripheral in time, guarantee the storage space of the network side, and improve processing efficiency of the network side.

What is claimed is:

1. A method for deregistering a terminal peripheral in a Machine Type Communication (MTC) system, comprising:
receiving, by a gateway, a first deregistration request message concerning the terminal peripheral, generating a second deregistration request message of the terminal peripheral, and sending the second deregistration request message of the terminal peripheral to a Machine to Machine (M2M) service platform or an M2M application; and
after receiving a first deregistration confirmation message of the terminal peripheral sent by the M2M service platform or the M2M application, deleting, by the gateway, information of local relevant terminal peripheral, and generating and sending a second registration confirmation message of the terminal peripheral to the terminal peripheral.

2. The method according to claim 1, wherein the first registration request message at least contains an identifier of the terminal peripheral to be deregistered.

3. The method according to claim 1, wherein the second deregistration request message at least contains an identifier of the gateway, the identifier of the terminal peripheral to be deregistered, or an identifier list of the terminal peripheral to be deregistered.

4. The method according to claim 3, wherein the generating the second deregistration request message of the terminal peripheral comprises:
after receiving the first registration request message of the terminal peripheral, immediately generating, by the gateway, the second registration request message of the terminal peripheral;
or, when a preset period comes, generating, by the gateway, the second deregistration request message;
or, when determining that a number of the terminal peripheral to be deregistered exceeds a preset threshold, generating, by the gateway, the second deregistration request message, wherein the preset threshold is larger than or equal to a maximum number of the terminal peripheral which can be carried by the identifier list of the terminal peripheral to be deregistered of the second deregistration request message.

5. The method according to claim 1, wherein the second deregistration confirmation message at least contains an identifier of a deregistered terminal peripheral; and
the first deregistration confirmation message at least contains the identifier of the deregistered terminal peripheral or an identifier list of the deregistered terminal peripheral.

6. The method according to claim 1, wherein the information of the local relevant terminal peripheral deleted by the gateway at least comprises an identifier of the terminal peripheral, and an address of the terminal peripheral.

7. The method according to claim 6, further comprising:
after receiving the second deregistration request message, deleting, by the M2M service platform or the M2M application, the information of the relevant terminal peripheral according to the identifier of the terminal peripheral or an identifier list of the terminal peripheral in the second deregistration request message, wherein the information of the relevant terminal peripheral at least comprises the identifier of the terminal peripheral, and the identifier of the gateway registered by the terminal peripheral.

8. A device for deregistering a terminal peripheral in a Machine Type Communication (MTC) system, comprising: a receiving unit, a generating unit, a deleting unit, and a sending unit, wherein
the receiving unit is configured to receive a first deregistration request message concerning the terminal peripheral, and to receive a first deregistration confirmation message of the terminal peripheral sent by a Machine to Machine (M2M) service platform or an M2M application;
the generating unit is configured to generate a second deregistration request message of the terminal peripheral, and to generate a second deregistration confirmation message of the terminal peripheral;
the deleting unit is configured to delete information of local relevant terminal peripheral after the receiving unit receives the first deregistration confirmation message; and
the sending unit is configured to send the second deregistration request message to the M2M service platform or the M2M application, and to send the second deregistration confirmation message to the terminal peripheral.

9. The device according to claim 8, wherein the first registration request message at least contains an identifier of the terminal peripheral to be deregistered.

10. The device according to claim 8, wherein the second deregistration request message at least contains an identifier of a gateway, the identifier of the terminal peripheral to be deregistered, or an identifier list of the terminal peripheral to be deregistered.

11. The device according to claim 8, wherein the generating unit is further configured to,
immediately generate the second registration request message of the terminal peripheral after receiving the first registration request message of the terminal peripheral;
or, generate the second deregistration request message when a preset period comes;
or, the generating unit is further configured to generate the second deregistration request message when determining that a number of the terminal peripheral to be deregistered exceeds a preset threshold, wherein the preset threshold is larger than or equal to a maximum number of the terminal peripheral which can be carried by an identifier list of the terminal peripheral to be deregistered of the second deregistration request message.

12. The device according to claim 8, wherein the second deregistration confirmation message at least contains an identifier of a deregistered terminal peripheral; and
the first deregistration confirmation message at least contains the identifier of the deregistered terminal peripheral or an identifier list of the deregistered terminal peripheral.

13. A gateway in a Machine Type Communication (MTC) system, comprising the device for deregistering the terminal peripheral according to claim 8.
